(19) United States
(12) Patent Application Publication
(10) Pub. No.: US 2005/0169486 A1
(43) Pub. Date: Aug. 4, 2005

(54) User controlled multi-channel audio conversion system

(75) Inventor: Roy Irwan, Ex Groningen (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/506,401

(22) PCT Filed: Feb. 7, 2003
(86) PCT No.: PCT/IB03/00488

(30) Foreign Application Priority Data
Mar. 7, 2002 (EP) 02075907.2

(51) Int. Cl. H04B 3/00

(52) U.S. Cl. 381/80; 381/77

(57) ABSTRACT

A multi-channel audio conversion system is described, comprising audio mode converting means having a signal input and a signal output for converting audio input signals to audio output signals representing audio in an audio output mode. The audio mode converting means are arranged for user controlled conversion from the audio input signals to the audio output signals. Advantageously the influencing of the conversion from audio input signals to audio output signals may take place by the listener. This results in a smooth and personalized freedom of choice regarding the amount of multi-channel stereo and/or surround effects in the audio output signals of the system.

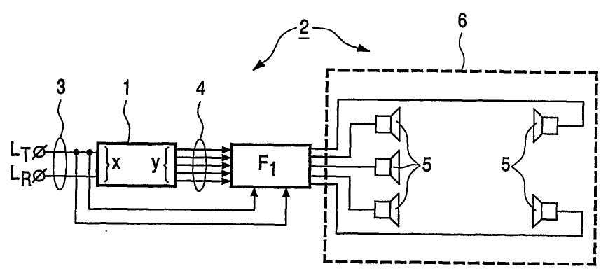

The present invention relates to a multi-channel audio conversion system, comprising audio mode converting means having a signal input and a signal output for converting audio input signals to audio output signals representing audio in an audio output mode.

The present invention also relates to a method for converting audio input signals to audio output signals representing audio in an audio output mode, and to signals used therein.

Such a multi-channel audio conversion system and method are known from WO 02/07481. The known system concerns a multi-channel stereo converter comprising a signal input and a signal output, whereby audio input signals having the stereo mode are converted to audio output signals having the surround mode. In particular the known system has stereo magnitude determining means coupled to said converter for influencing the audio signal conversion. This allows broader audio mode conversion without introducing cross talk. In practice the mode conversion—in particular a stereo to surround mode conversion—may either be applied or not. This may lead to a rather jerky behavior in the varying perception of output audio, in particular if music and speech alternate.

Therefore it is an object of the present invention to provide an improved multi-channel audio conversion system capable of applying smooth multi-channel mode techniques.

Thereto the multi-channel audio conversion system according to the invention is characterized in that the audio mode converting means are arranged for user controlled conversion from the audio input signals to the audio output signals.

Similarly the method according to the invention is characterized in that the conversion is a user controlled audio mode conversion.

It is an advantage of the multi-channel audio conversion system and method according to the invention that the user controlled dependency of the audio conversion, results in a smooth and personalized freedom of choice regarding the amount of multi-channel stereo and/or surround effects in the audio output signals of the system. In addition if chosen for a stereo or surround mode, the chosen output mode may be appropriate for music, but it can now smoothly be optimized, either manually or automatically and gradually changed to another mode for the proper perception of speech. A similar advantages hold, if starting from speech one concerns the proper perception of music. The chosen output mode may even be a user controlled mixture to include partial stereo and partial surround effects. The percentages of these partial effects may be user controlled as well.

An embodiment of the multi-channel audio conversion system according to the invention is characterized in that the audio mode converting means define a conversion matrix comprising one or more user controlled functions.

This for example allows a stereo or stereo surround signal to be converted to a new stereo or stereo surround signal, which takes account of the respective continuous functions reflecting the smoothed personalized and wanted perception.

A further embodiment of the multi-channel audio conversion system according to the invention is characterized in that the user controlled functions are also dependent on one or more of the following quantities:
(a) the respective magnitudes of the audio input signals and/or audio output signals;
(b) the respective frequency spectra and/or spectral distribution of spectral components of the audio input signals and/or audio output signals; and/or
(c) the type of audio, such as speech, movie mode, and the kind of music. In practical situations this may allow the listener to make his specific multi-dependent adjustments. These may for example dependent on her or his home situation, such as the positioning of the loudspeakers in the room.

A practical and simple embodiment of the multi-channel audio conversion system according to the invention is characterized in that at least one of the user controlled functions is dependent on one variable.

With this simple embodiment it is easy to implement a circuit which is capable of continuously adjusting the amount of multi-channel effect until a wanted amount of such effect is achieved. Preferably the value of the one variable ranges between 0 and 1, such that for example 0 represents full stereo and 1 represents full surround. More preferably the value of the one variable then lies around 0.5.

The multi-channel audio conversion system according to the invention may have three or more audio channels for implementing a full stereo spatial surround system.

At present the multi-channel audio conversion system and method according to the invention will be elucidated further together with their additional advantages, while reference is being made to the appended sole drawing showing a schematic view of a five channel audio conversion system implementing a possible embodiment of the audio conversion system according to the invention.

The Figure in particular shows a stereo to five channel Dolby pro logic decoder 1 implementing audio converting means in an audio system 2. The audio converting means 1 has a signal input 3 and a signal output 4. The outputs 4 are coupled are coupled to respective loudspeakers 5 in a room 6. Provisions may be made in the system 2 for avoiding multi-channel echoes. If the output signals are designated Y and the input signals are designated X, then in a general case the relation between output and input signals is given by:
Y=FX (1)
where F is a matrix having components in the form of user controlled functions. The number of columns of the matrix F corresponds to the number of signals x in the input signal X and the number of rows of the matrix corresponds to the number of signals y in the output signal Y.

Narrowed down, equation (1) can for example be written as:

$$( \begin{matrix}L \\ R \\ C \\ {L}_{s} \\ {R}_{s}\end{matrix} ) = {F}_{1} \times ( \begin{matrix}{L}_{T} \\ L \\ {R}_{T} \\ R \\ C \\ {S}_{L} \\ {S}_{R}\end{matrix} ) \qquad ( 2 )$$

Where F₁ now is a 5×7 matrix, L_{T} and R_{T} are true left and right stereo signals such as present at signal input 3, L and R are left and right signals, C is the center signal, and S_{L} and S_{R} are left surround and right surround signals respectively. Equation 2 can be implemented in the audio system 2 in a way also shown in the sole figure. If now one considers the decoder 1 to be a known two-to-five decoder converting stereo at input 3 to five channel surround at output 4, the user controlled matrix means indicated F₁—now forming the user controlled audio converting means—can simply be interconnected between output 4 and the loudspeakers 5. Apart from the five surround signals on output 4 the two true stereo signals on input 3 are here also used as input to user controlled 5×7 matrix means F₁ in order to smoothly personalize the wanted audio perception.

At least one of the components of the matrix F or F₁ as the case may be—some of them being zero—are here user controlled functions. In addition they may depend on for example the following quantities:
(a) the respective magnitudes of the audio input signals and/or audio output signals;
(b) the respective frequency spectra and/or spectral distribution of spectral components of the audio input signals and/or audio output signals; and/or
(c) the type of audio, such as speech, movie mode, and the kind of music. At wish for example the dominant signal of the stereo signals may be reproduced by the center signal C. The dominant signal may contain vocals, such as in music and dialogues, such as in movies. The difference of the constituents of the dominant signal may then be reflected in one of the above quantities, such that the appropriate output signal of the converting means 1 in the form of the center signal C is emphasized. This generally is desirable for movies, since it sharpens the dialogues and therefore the view of the listener to the film screen, whereas for music it appears to be less attractive to position vocals to the center speaker, since it provides a kind of synthetic effect. Advantageously such effects can be adjusted, at wish. What can be marketed is a kind of user interface, allowing the consumer to adjust the amount and percentage of for example stereo and surround effects respectively. By doing so, the user has the freedom to choose personally the width of the vocals heard from the loudspeakers 5.

The user controlled component functions of the matrix F or F₁ as the case may be, may depend on only one variable, as explained by the following equations, where the left terms are the output signals of the audio converting means 1:
L_{new}=αL_{T}+(1−α)L
R_{new}=αR_{T}+(1−α)R
C_{new}=(1−α)C
S_{Lnew}=(1−α)S_{L}
S_{Rnew}=(1−α)S_{R},
where 0≦α≦1.

Thus if the user adjusts α=1 then normal stereo is heard, and if a α=0 a five channel audio surround reproduction is heard with the vocal in the center C. For music it can then be desirable to set a around 0.5 to have more spread vocals in the front channels, as well as a good balance between stereo and processed new surround stereo.

1. A multi-channel audio conversion system, comprising audio mode converting means having a signal input and a signal output for converting audio input signals to audio output signals representing audio in an audio output mode, characterized in that the audio mode converting means are arranged for user controlled conversion from the audio input signals to the audio output signals.

2. The multi-channel audio conversion system according to claim 1, characterized in that the audio mode converting means define a conversion matrix comprising one or more user controlled functions.

3. The multi-channel audio conversion system according to claim 2, characterized in that the user controlled functions are also dependent on one or more of the following quantities:
(a) the respective magnitudes of the audio input signals and/or audio output signals;
(b) the respective frequency spectra and/or spectral distribution of spectral components of the audio input signals and/or audio output signals; and/or
(c) the type of audio, such as speech, movie mode, and the kind of music.

4. The multi-channel audio conversion system according to one of the claims 2 and 3, characterized in that at least one of the user controlled functions are dependent on one variable.

5. The multi-channel audio conversion system according to claim 4, characterized in that the value of the one variable ranges between 0 and 1.

6. The multi-channel audio conversion system according to claim 5, characterized in that the value of one variable lies around 0.5.

7. The multi-channel audio conversion system according to one of the claims 1-6, characterized in the multi-channel audio system has three or more audio output channels for presenting the audio output signals.

8. A method for converting audio input signals to audio output signals representing audio in an audio output mode, characterized in that the conversion is a user controlled audio mode conversion.

9. The method according to claim 8, characterized in that the user controlled audio mode conversion is also dependent on one or more of the following quantities:
(a) the respective magnitudes of the audio input signals and/or audio output signals;
(b) the respective frequency spectra and/or spectral distribution of spectral components of the audio input and/or audio output signals; and/or
(c) the type of audio, such as speech, movie mode, and the kind of music.

10. Signals for use in the multi-channel audio conversion system according to one of the claims 1-7, characterized in that the signals reflect a user controlled audio mode conversion applied by method according to one of the claims 8 and 9.
